(19) United States
(12) Patent Application Publication
(10) Pub. No.: US 2012/0125467 A1
(43) Pub. Date: May 24, 2012

(54) AIR GUIDE AND AIR-GUIDING SYSTEM

(76) Inventor: Meng-Sheng CHIU, Iaoyuan Hsien (TW)

(21) Appl. No.: 13/044,945

(22) Filed: Mar. 10, 2011

(30) Foreign Application Priority Data
Nov. 19, 2010 (TW) 099222449

(51) Int. Cl. F16L 55/00

(52) U.S. Cl. 138/103

(57) ABSTRACT

An air guide includes a tube body, a first guiding plate and a second guiding plate. The tube body has an outlet. The first guiding plate and the second guiding plate are disposed in the tube body. One end of the second guiding plate away from the outlet is protruded with respect to the first guiding plate by a first length.

### CROSS REFERENCE TO RELATED APPLICATIONS

This Non-provisional application claims priority under 35 U.S.C. §119(a) on Patent Application No(s). 099222449 filed in Taiwan, Republic of China on Nov. 19, 2010, the entire contents of which are hereby incorporated by reference.

### BACKGROUND OF THE INVENTION

1. Field of Invention

The present invention relates to an air guide and, in particular, to an air guide applied to the lamp module of projectors.

2. Related Art

The projectors have been widely used in offices and are thus indispensable. Based on the configurations, the projectors can be divided into the desktop type projectors and the ceiling type projectors. However, both types of projectors have the heat dissipation issue to be improved. To solve the heat dissipation issue, the manufacturers have tried to increase the rotary speed of the fan in the projector to enhance the output performance. However, this solution is not good enough because the symmetry and uniformity of the heat-dissipating flow field with respect to the lamp module are poor.

FIG. 1 is a partial perspective view of the conventional air guide in the projector. As shown in FIG. 1, the conventional air guide 1 includes a tube body 11, which has an inlet 111 and an outlet 112 located at two ends of the tube body 11. Due to the limitation of the dimension of the projector, the tube body 11 usually has a turning portion 113, so that the fan, which is connected to the inlet 111 and is located at different horizontal plane from the inlet 111, can still blow air into the tube body 11 and achieving the lamp module (as the path A shown in FIG. 1). However, as shown in FIG. 1, when the air flows through the turning portion 113, the flow field at the outlet 112 is not symmetric. Thus, the air outputted from the outlet 112 flows downwards obviously, which leads to the poor uniformity of the heat dissipation effect. Therefore, the lamp module may not be maintained at the normal operation temperature, and thus the lifespan of the projector is seriously affected.

Therefore, it is an important subject to provide an air guide structure that can improve the symmetry and uniformity of the air flow field at the outlet without increasing the total volume of the airflow channel, thereby actually controlling the operation temperature of the lamp module and effectively improving the lifespan of the projector.

### SUMMARY OF THE INVENTION

In view of the foregoing subject, an objective of the present invention is to provide an air guide structure that can improve the symmetry and uniformity of the air flow field at the outlet without increasing the total volume of the airflow channel, thereby actually controlling the operation temperature of the lamp module and effectively improving the lifespan of the projector.

To achieve the above objective, the present invention discloses an air guide including a tube body, a first guiding plate and a second guiding plate. The tube body has an outlet. The first guiding plate and the second guiding plate are disposed in the tube body. One end of the second guiding plate away from the outlet is protruded with respect to the first guiding plate by a first length. Herein, the first guiding plate and the second guiding plate are horizontally disposed in the tube body. Preferably, the tube body further has an inlet, and the first guiding plate is closer to the inlet than the second guiding plate.

In one embodiment of the present invention, the air guide has at least one turning portion, and the first guiding plate and the second guiding plate are disposed between the turning portion and the outlet.

In one embodiment of the present invention, one end of the first guiding plate and/or one end of the second guiding plate near the outlet is located on the same plane as the outlet.

In one embodiment of the present invention, the air guide further includes a third guiding plate disposed in the tube body. One end of the third guiding plate away from the outlet is protruded with respect to the second guiding plate by a second length, which is equal to the first length.

In one embodiment of the present invention, the air guide is integrally formed as one piece.

To achieve the above objective, the present invention also discloses an air-guiding system, which is applied with a lamp module and includes a fan, an air guide and an outlet structure. The air guide is disposed adjacent to the lamp module, and includes a tube body, a first guiding plate, and a second guiding plate. The tube body has an inlet connecting to the fan and an outlet. The first guiding plate and the second guiding plate are disposed in the tube body. One end of the second guiding plate away from the outlet is protruded with respect to the first guiding plate by a first length. The outlet structure is disposed adjacent to the lamp module. Preferably, the first guiding plate is closer to the inlet than the second guiding plate.

In one embodiment of the present invention, the air guide has at least one turning portion, and the first guiding plate and the second guiding plate are disposed between the turning portion and the outlet.

In one embodiment of the present invention, one end of the first guiding plate and/or one end of the second guiding plate near the outlet is located on the same plane as the outlet.

In one embodiment of the present invention, the air guide further includes a third guiding plate disposed in the tube body. One end of the third guiding plate away from the outlet is protruded with respect to the second guiding plate by a second length, which is equal to the first length.

In one embodiment of the present invention, the air guide is integrally formed as one piece.

As mentioned above, the air guide and air-guiding system of the present invention are configured with two parallel guiding plates, which have different lengths at one end away from the outlet, so as to obtain the stepwise guiding plate structure. Thus, in the air guide having the turning portion for fitting the limited space, the preset flow channels can be formed between the guiding plates, and they can guide the airflow and maintain the symmetry and uniformity of the flow field outside the outlet. For both desktop type and ceiling type projectors, the flow field thereof is not interfered, so that the heat of the lamp can be properly took away and it may operate at the proper operation temperature. Furthermore, if the volume of the air guide is decreased, the stepwise guiding plates can still keep the symmetry of the flow field and the heat-dissipating efficiency. This feature can sufficiently decrease the manufacturing cost and facilitate the designs of projector appearance. Compared with the conventional projector, which has the problem of the undesired flow field caused by the downward airflow from the outlet that leading to the poor uniformity of lamp heat dissipation and the decreased lifespan of the projector, the present invention can solve the problem thereof.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a partial perspective view of the conventional air guide in the projector;

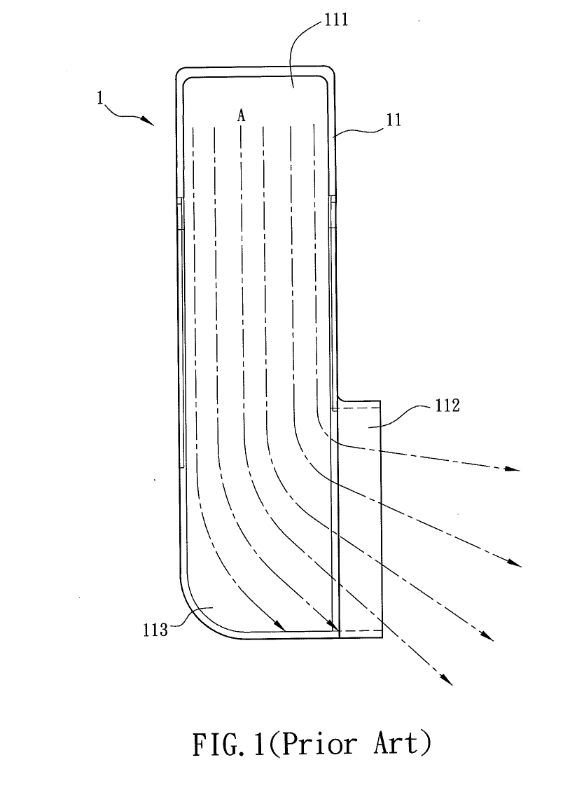

FIG. 2 is a rear view of an air guide according to a first embodiment of the present invention;

FIG. 3 is a schematic diagram showing the airflow direction in the air guide according to the present invention;

FIG. 4A is a rear view of an air guide according to a second embodiment of the present invention;

FIG. 4B is a schematic diagram showing the airflow direction in the air guide according to the second embodiment of the present invention;

FIG. 5 is a schematic diagram showing an air-guiding system, which is located in the projector, according to a first embodiment of the present invention;

FIG. 6 is a partial enlarged view of an air-guiding system according to a third embodiment of the present invention; and

FIG. 7 is a schematic diagram showing the whole air-guiding system of FIG. 6.

### DETAILED DESCRIPTION OF THE INVENTION

The present invention will be apparent from the following detailed description, which proceeds with reference to the accompanying drawings, wherein the same references relate to the same elements.

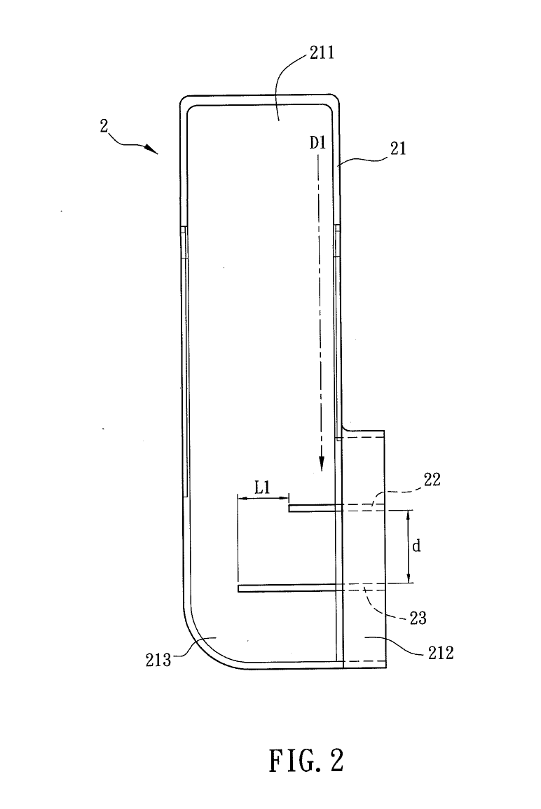

FIG. 2 is a rear view of an air guide according to a first embodiment of the present invention. In this embodiment, the air guide is preferably applied to a projector for maintaining the lamp module to operate at the normal operation temperature. As shown in FIG. 2, the air guide 2 includes a tube body 21, a first guiding plate 22 and a second guiding plate 23. The first guiding plate 22 and the second guiding plate 23 are both disposed in the tube body 21, and they are preferably parallel to each other and vertically separated with a distance d. Two sides of the first guiding plate 22 and two sides of the second guiding plate 23 are connected to the tube body 21. Accordingly, the first guiding plate 22, the second guiding plate 23 and the tube body 21 can define an airflow channel, which has a height d and a width the same as the guiding plates.

The tube body 21 has an inlet 211 and an outlet 212. In this case, the inlet 211 is the portion of the air guide 2 for connecting to the fan (not shown), thereby guiding the airflow entering into the air guide 2. In contrast, the outlet 212 is the portion of the air guide 2 where the airflow leaves to form the desire flow filed for cooling the target. With reference to FIG. 2, one end of the second guiding plate 23 away from the outlet 212 is protruded with respect to the first guiding plate 22 by a first length L1. In other words, regarding to the vertical projection, one end of the second guiding plate 23 away from the outlet 212 is longer than the first guiding plate 22 by the first length L1.

In addition, the other ends of the first guiding plate 22 and the second guiding plate 23 close to the outlet 212 are not limited, and they are preferred to have the same length. In other words, regarding to the vertical projection, the end of the first guiding plate 22 close to the outlet 212 is at the same position as that of the second guiding plate 23.

In addition, the air guide 2 further includes a turning portion 213, and the first guiding plate 22 and the second guiding plate 23 are horizontally disposed between the turning portion 213 and the outlet 212. To be specified, the turning portion 213 and the outlet 212 both cover their neighbor areas and are not limited to specific locations.

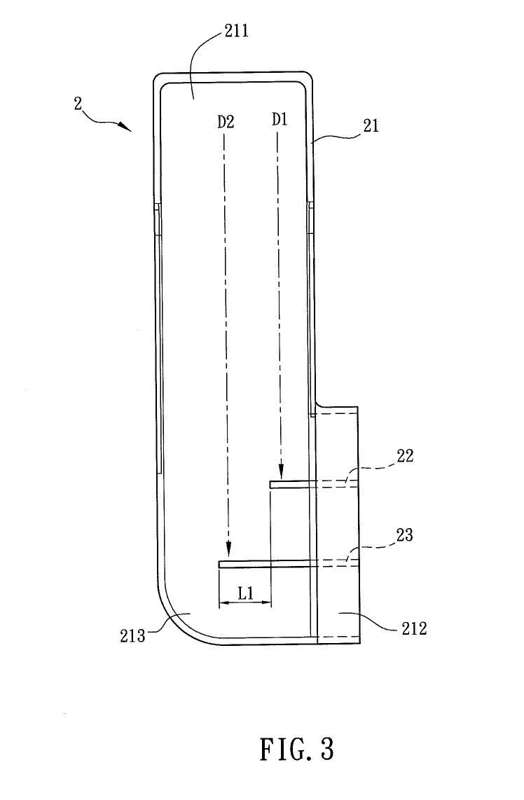

Referring to FIG. 3, after the airflow D1 and airflow D2 flow through the inlet 211, they will meet the above-mentioned structure in the turning portion 213. In the turning portion 213, the airflow D1 and airflow D2 reach the first guiding plate 22 and the protruding part of the second guiding plate, which has the first length L1, and are then guided toward the outlet 212. In this case, the airflow D1 and airflow D2 will not collide with and be reflected by the side wall of the turning portion 213. Thus, the outlet 212 can output steady airflows D1 and D2 so as to generate the desired symmetric flow field. To be noted, if the distance between the fan and the target is longer, there may be more turning portions 213 configured in the tube body 21 of the air guide 2. No matter how many turning portions 213 are configured, the first guiding plate 22 and the second guiding plate 23 are disposed between the outlet 212 and the latest turning portion 213, which is closest to the outlet 212.

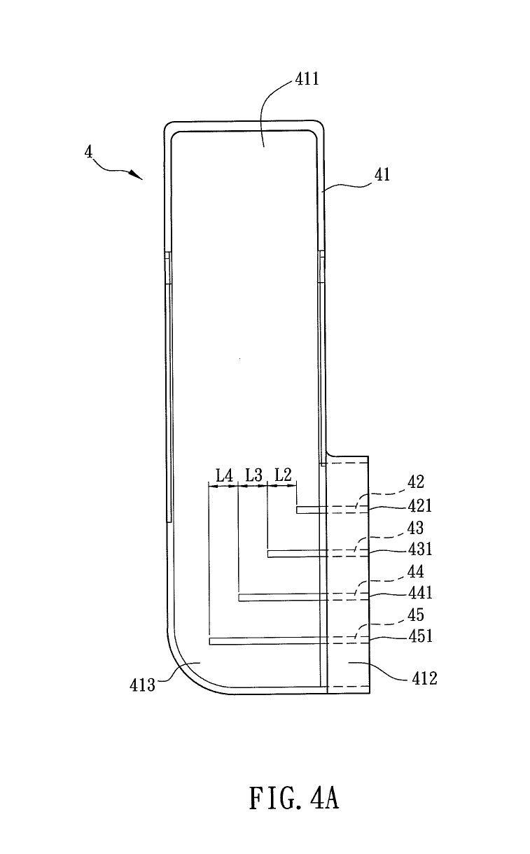

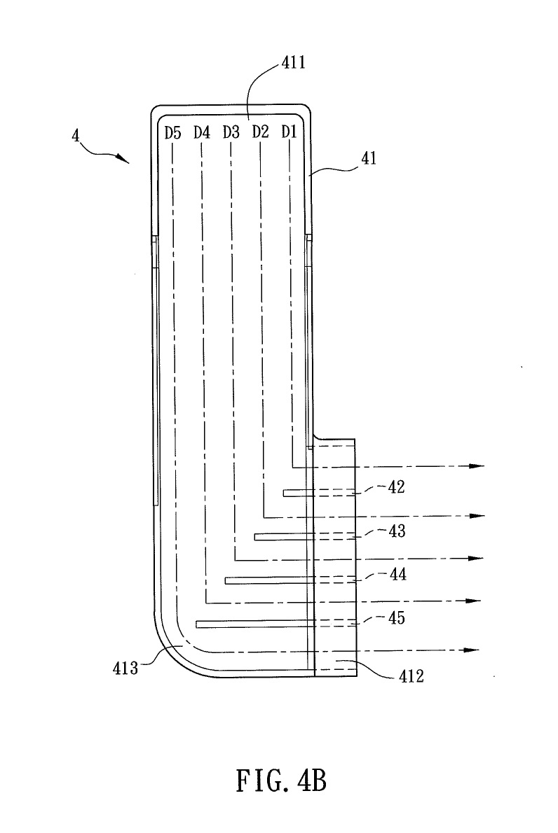

FIG. 4A is a rear view of an air guide 4 according to a second embodiment of the present invention. As shown in FIG. 4A, the air guide 4 further includes a third guiding plate 44 and a fourth guiding plate 45, which are configured the same as the first guiding plate 42 and the second guiding plate 43. One end of the second guiding plate 43 away from the outlet 412 is protruded with respect to the first guiding plate 42 by a first length L2. One end of the third guiding plate 44 away from the outlet 412 is protruded with respect to the second guiding plate 43 by a second length L3. One end of the fourth guiding plate 45 away from the outlet 412 is protruded with respect to the third guiding plate 44 by a third length L4. Preferably, the third length L4 is equal to the second length L3. In practice, according to the same concept, the air guide 4 may further include a fifth guiding plat, a sixth guiding plate, a seventh guiding plate, . . . , an nth guiding plate, and so on. In this case, the number of the guiding plates can be determined according to the internal diameter of the air guide 4. To be noted, any of the configured guiding plates should not contact with the side wall of the tube body 41 around the turning portion 413 so as to remain the spaces for airflow.

Referring to FIG. 4B, the guiding plate away from the inlet 411 has a protruding portion, which is located at one end of the guiding plate away from the outlet 412, with respect to the other guiding plate close to the inlet 411. For example, the first guiding plate 42 is closer to the inlet 411 than the second guiding plate 43, so one end of the second guiding plate 43 is protruded with respect to the first guiding plate 42. Accordingly, the air guide 4 includes four guiding plates 42-45, which have different lengths, so that the stepwise guiding plate structure, which is configured between the turning portion 413 and the outlet 412 and perpendicular to the directions of the airflows D1-D5, can be obtained. As shown in FIG. 4B, the airflows D1-D5 are respectively guided by the guiding plates 42-45 and then flow through the airflow channels formed by the adjacent two guiding plates or between the tube body 41 and the guiding plates 42 and 45. Thus, the airflows D1-D5 can be outputted from the outlet 412 in parallel, so that the downward airflow in the prior art can be eliminated in both the desktop and ceiling type projectors.

To be specified, one end of the first guiding plate 42 and/or one end of the second guiding plate 43, which is near the outlet 412, can be located on the same plane as the outlet 412. This configuration is for example only and is not to limit the present invention. For example, one end of the first guiding plate 42 and/or one end of the second guiding plate 43, which is near the outlet 412, may be located on different plane from the outlet 412. In this embodiment, as shown in FIG. 4A, the ends 421, 431, 441 and 451 of the first, second, third and fourth guiding plates 42, 43, 44 and 45, which are near the outlet 412, are located on the same vertical plane. In other words, the four guiding plates 42, 43, 44 and 45 are not protruded from each other. In addition, the air guide 4 of this embodiment is integrally formed as one piece, or it can be assembled by separate independent components including the tube body 41 and the guiding plates 42, 43, 44 and 45. The material of the air guide 4 may include plastic material, metal or plastic material doped with metal.

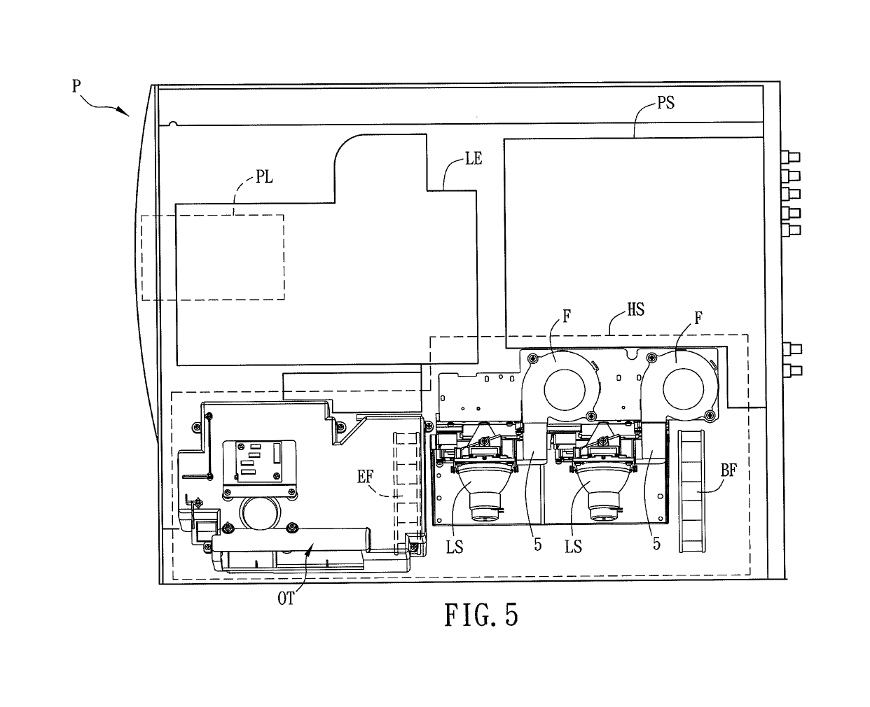

In addition, the present invention also discloses an air-guiding system. With reference to FIG. 5, the air-guiding system HS is preferably installed in a projector P for keeping the lamp module LS of the projector P to operate at the normal operation temperature. In particular, the projector P is the projecting machine for outdoor projection, which may include two sets of lamp modules LS. In more detailed, the projector P includes a power system PS, a lens module PL, and an optical system LE. Because the projector P of this embodiment has two sets of lamp modules LS, the air-guiding system HS includes two fans F, two air guides 5, and an outlet structure OT. The air guides 5 are applied with the lamp modules LS, respectively, and each air guide 5 is disposed at one side of the lamp module LS. The outlet structure OT is disposed at the other side of the lamp module LS opposite to the air guide 5. In practice, however, the numbers and configurations of the elements in the air-guiding system HS and the lamp modules LS can be adjusted according to different specifications of projectors, and are not limited to this embodiment.

The fan F can generate the airflow, which passes through the air guide 5 of the air-guiding system HS for taking the heat generated by the lamp module LS. Then, the airflow becomes the hot air and then flows out of the projector P through the outlet structure OT.

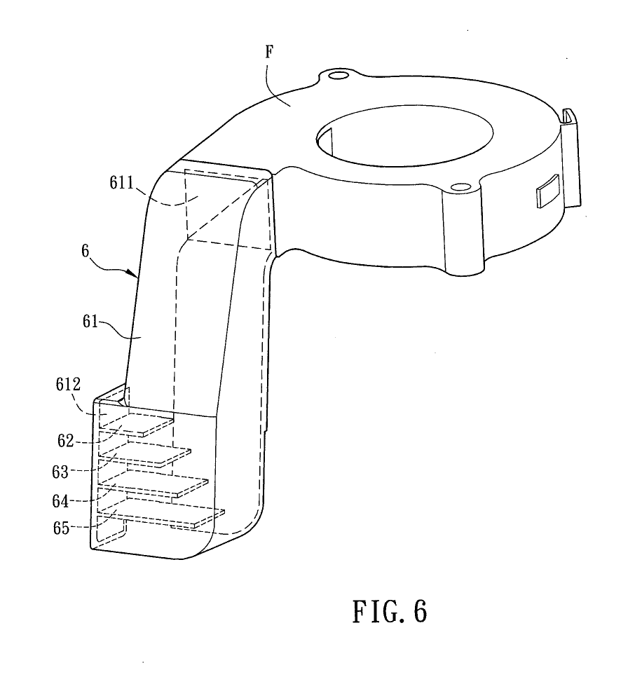

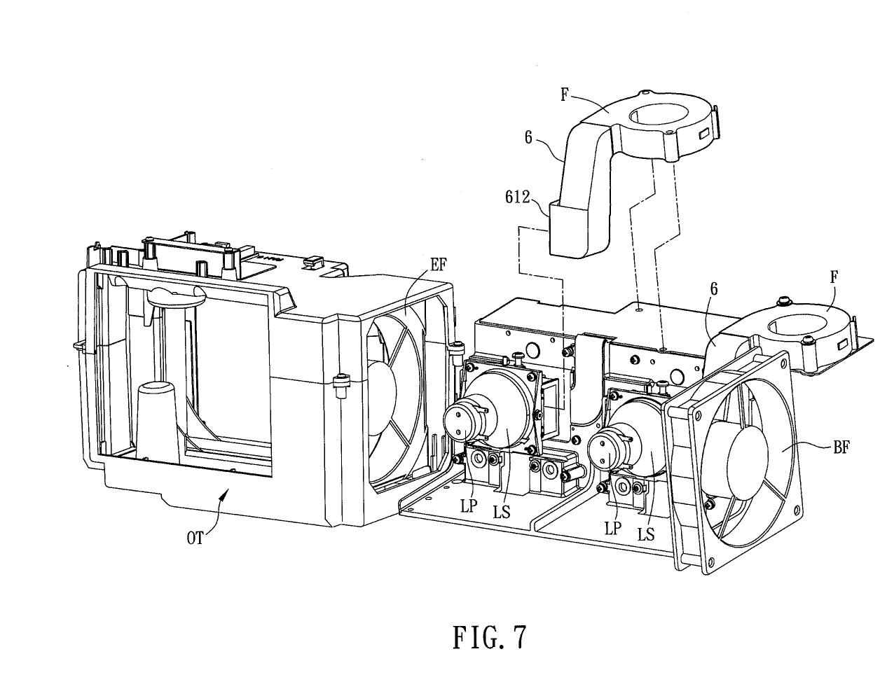

FIG. 6 is a partial enlarged view of an air-guiding system according to a third embodiment of the present invention, and FIG. 7 is a schematic diagram showing the whole air-guiding system of FIG. 6. Referring to FIGS. 6 and 7, an air guide 6 includes a tube body 61, a first guiding plate 62, a second guiding plate 63, a third guiding plate 64, and a fourth guiding plate 65. The tube body 61 has an inlet 611 connecting to the fan F and an outlet 612. The guiding plates 62-65 are all disposed in the tube body 61. The ends of the guiding plates away from the outlet 612 have different lengths. For example, one end of the second guiding plate 63 away from the outlet 612 is protruded with respect to the first guiding plate 62 by a first length. The configurations and relationships of the residual guiding plates are similar to this. The detailed structure of the air guide 6 is the same as the above-mentioned air guide 4 of the previous embodiment of FIG. 4, so the description thereof will be omitted. In addition, the fan F of this embodiment is a blowing fan.

With reference to FIGS. 5 and 7, the lamp module LS of this embodiment includes at least one lamp LP such as a UHP (ultra high performance) lamp or a ME (ultra high efficiency) lamp. The outlet structure OT further includes a plurality of fins and at least one exhaust fan EF. The configured fins can also prevent the light leakage of the projector. Furthermore, the air-guiding system HS may further cooperate with a blowing fan BF. In this case, the exhaust fan EF and the lamp module LS are located at the same side of the air guide 6, and the blowing fan BF is located at the opposite side of the air guide 6. For example, the fans can be turbo fans, axial fans, multi-blade fans, or negative-pressure fans.

The airflow path inside the air-guiding system HS will be further illustrated hereinbelow with reference to FIG. 7. Firstly, the airflow generated by the fan F travels along an airflow path in the air guide 6, and then reaches the lamp module LS after passing through the outlet 612. The lamp LP of the lamp module LS as well as its internal lamp core is disposed about the outlet 612 of the air guide 6. The airflow outputted from the air guide 6 can form a uniform and symmetric flow field at the exit of the outlet 612, so that the entire lamp LP and its lamp core can be uniformly cooled down. Thus, the lamp LP can be maintain at the proper operation temperature, and the problem of the prior art that the non-uniform heat dissipation caused by the downward airflow (e.g. the upper side of the lamp LP has higher temperature and the lower side thereof has lower temperature) can be prevented. Moreover, the airflow generated by the blowing fan BF can further increase the quantity and intensity of the total airflow passing through the lamp module LS. Besides, the exhaust fan EF can also speed the exhaustion of the hot air inside the lamp module LS so as to achieve the rapid heat-dissipating efficiency.

In summary, the air guide and air-guiding system of the present invention are configured with two parallel guiding plates, which have different lengths at one end away from the outlet, so as to obtain the stepwise guiding plate structure. Thus, in the air guide having the turning portion for fitting the limited space, the preset flow channels can be formed between the guiding plates, and they can guide the airflow and maintain the symmetry and uniformity of the flow field outside the outlet. For both desktop type and ceiling type projectors, the flow field thereof is not interfered, so that the heat of the lamp can be properly took away and it may operate at the proper operation temperature. Furthermore, if the volume of the air guide is decreased, the stepwise guiding plates can still keep the symmetry of the flow field and the heat-dissipating efficiency. This feature can sufficiently decrease the manufacturing cost and facilitate the designs of projector appearance. Compared with the conventional projector, which has the problem of the undesired flow field caused by the downward airflow from the outlet that leading to the poor uniformity of lamp heat dissipation and the decreased lifespan of the projector, the present invention can solve the problem thereof.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An air guide comprising:
a tube body having an outlet;
a first guiding plate disposed in the tube body; and
a second guiding plate disposed in the tube body, wherein one end of the second guiding plate away from the outlet is protruded with respect to the first guiding plate by a first length.

2. The air guide according to claim 1, wherein the first guiding plate and the second guiding plate are horizontally disposed in the tube body.

3. The air guide according to claim 1, wherein the tube body further comprises an inlet, and the first guiding plate is closer to the inlet than the second guiding plate.

4. The air guide according to claim 1, wherein the air guide has at least one turning portion, and the first guiding plate and the second guiding plate are disposed between the turning portion and the outlet.

5. The air guide according to claim 1, wherein one end of the first guiding plate and/or one end of the second guiding plate near the outlet is located on the same plane as the outlet.

6. The air guide according to claim 1, further comprising:
a third guiding plate disposed in the tube body, wherein one end of the third guiding plate away from the outlet is protruded with respect to the second guiding plate by a second length, and the first length is equal to the second length.

7. The air guide according to claim 1, which is integrally formed as one piece.

8. An air-guiding system applied with a lamp module, comprising:
a fan;
an air guide disposed adjacent to the lamp module, wherein the air guide comprises a tube body, a first guiding plate, and a second guiding plate, the tube body has an inlet and an outlet, the inlet connects to the fan, the first guiding plate and the second guiding plate are disposed in the tube body, and one end of the second guiding plate away from the outlet is protruded with respect to the first guiding plate by a first length; and
an outlet structure disposed adjacent to the lamp module.

9. The air-guiding system according to claim 8, wherein the first guiding plate and the second guiding plate are horizontally disposed in the tube body.

10. The air-guiding system according to claim 8, wherein the first guiding plate is closer to the inlet than the second guiding plate.

11. The air-guiding system according to claim 8, wherein the air guide has at least one turning portion, and the first guiding plate and the second guiding plate are disposed between the turning portion and the outlet.

12. The air-guiding system according to claim 8, wherein one end of the first guiding plate and/or one end of the second guiding plate near the outlet is located on the same plane as the outlet.

13. The air-guiding system according to claim 8, wherein the air guide further comprises a third guiding plate disposed in the tube body, one end of the third guiding plate away from the outlet is protruded with respect to the second guiding plate by a second length, and the first length is equal to the second length.

14. The air-guiding system according to claim 8, wherein the air guide is integrally formed as one piece.
